(19) United States
(12) Patent Application Publication
(10) Pub. No.: US 2015/0322712 A1
(43) Pub. Date: Nov. 12, 2015

(54) CONTROL UNIT FOR CONTROLLING THE COLOR OF A WINDOW

(71) Applicant: KONINKLIJKE PHILIPS N.V., AE Eindhoven (NL)

(72) Inventors: Johannes Petrus Wilhelmus Baaijens, Eindhoven (NL); Kars-Michiel Hubert Lenssen, Veldhoven (NL); Arend Jan Wilhelmus Abraham Vermeulen, Drachtster Compagnie (NL)

(21) Appl. No.: 14/762,580

(22) PCT Filed: Jan. 22, 2014
(86) PCT No.: PCT/IB2014/058452

§ 371 Date: Jul. 22, 2015

Related U.S. Application Data
(60) Provisional application No. 61/757,760, filed on Jan. 29, 2013.

(51) Int. Cl. E06B 9/24; G05B 15/02; G02F 1/167

(52) U.S. Cl. CPC E06B 9/24; G02F 1/167; G05B 15/02

(57) ABSTRACT

According to an aspect, a control unit (130) adapted to be communicatively coupled to a window (110) is provided. The window is adapted to controllably effect changing of color temperature of light transmitted through the window. The control unit is configured to obtain a signal indicative of the color temperature of light which is to be, and/or has been, transmitted through the window, and control the window at least with respect to color temperature of light transmitted through the window based at least on the signal indicative of color temperature. With the present control unit, it may be possible to maintain a certain color temperature even if the color temperature of the light to be transmitted through the window changes.

### FIELD OF THE INVENTION

The present invention generally relates to the field of windows adapted to controllably effect changing of characteristics of light transmitted through the window. In particular, the present invention relates to control units for such windows.

### BACKGROUND OF THE INVENTION

Electrically controllable windows may be used for dimming light transmitted through the window. Such windows may be referred to as “smart windows” and are increasingly popular for enhancing energy efficiency of buildings. Such windows may be used instead of mechanical blinds for lowering heat radiation input from the sun into a building, thereby decreasing cooling demands. An example of a system comprising an electro chromic smart window is disclosed in US 2009/0187287. The system further comprises an illumination system for compensating lack of daylight when the window becomes less transparent.

### SUMMARY OF THE INVENTION

It would be advantageous to find new applications for windows adapted to controllably effect changing of characteristics of light transmitted through the window. It would also be desirable to achieve more comfortable daylight illumination in buildings. To better address these concerns, a control unit for a window as defined in the independent claim is provided. Preferable embodiments are defined in the dependent claims.

Hence, according to an aspect, a control unit adapted to be communicatively coupled to a window is provided. The window is adapted to controllably effect changing of color temperature of light transmitted through the window. The control unit is configured to obtain a signal indicative of the color temperature of light which is to be, and/or has been, transmitted through the window, and control the window at least with respect to color temperature of light transmitted through the window based at least on the signal indicative of color temperature.

Previously, windows adapted to controllably effect changing of characteristics of light transmitted through the window (which hereinafter may be referred to as smart windows) have been used to replace mechanical sun blinds for reducing heat radiation. The inventors have realized that smart windows can be used for a new field of application, namely, for controlling color temperature indoor illumination. Daylight normally has a relatively high color temperature, such as around 5000 K. However, indoor illumination may be perceived as more comfortable by a viewer if it has a lower color temperature. With the present aspect, the color temperature of light transmitted through the window can be adjusted. The change of color temperature of incoming light (i.e. light transmitted through the window) effected by the window is based on the sensed color temperature (on either side of the window), whereby it may be possible to maintain a certain color temperature even if the color temperature of the light to be transmitted through the window changes. The color temperature of daylight at noon may e.g. be higher than the color temperature of daylight at sunset.

According to an embodiment, a system may be provided. The system may comprise a window adapted to controllably effect changing of color temperature of light transmitted through the window, and a control unit as defined above for controlling the window. According to an embodiment, the system may further comprise a sensor configured to sense color temperature of light which is to be, and/or has been, transmitted through the window, and transmit a signal indicative of the sensed color temperature to the control unit.

According to an embodiment, the control unit may further be configured to control the window to effect change of color temperature of light transmitted through the window to a color temperature below 4000 K, preferably below 3400 K, and most preferably below 2700 K, based at least on the signal indicative of color temperature. Lower color temperatures (such as below 4000 K) are normally perceived as more comfortable by a viewer for indoor illumination compared to higher color temperatures (such as above 4000 K). With the present embodiment, tuning of light from a relatively high color temperature (such as around 5000 K) down to color temperatures below 4000 K is enabled. Illumination from the window may then better resemble illumination from conventional indoor luminaries (which normally have a lower color temperature compared to daylight).

According to an embodiment, the control unit may further be configured to obtain a signal indicative of the brightness of light which is to be, and/or has been, transmitted through the window, and control the window based on the signal indicative of the brightness. Hence, brightness may also be taken into account when controlling the window. Using more light parameters for controlling the window may provide more accurate control of the illumination provided by the window.

According to an embodiment, the window may be further controllable with respect to the extent of light allowed to be transmitted through the window and the control unit may be further configured to control the window with respect to the extent of light allowed to be transmitted through the window based on the signal indicative of the brightness. Daylight (in particular around noon) may have relatively high brightness, such as above 5000 lux. However, indoor illumination may be perceived as more comfortable by a viewer if it has lower brightness. With the present embodiment, the brightness of light transmitted through the window can be adjusted. The change of brightness of incoming light (i.e. light transmitted through the window) effected by the window may be based on the sensed brightness (on either side of the window), whereby it may be possible to maintain a certain brightness even if the brightness of the light to be transmitted through the window changes.

According to an embodiment, the control unit may further be configured to control the window with respect to the extent of light allowed to be transmitted through the window such that light transmitted through the window has an average brightness below 1000 lux, and preferably below 500 lux, based on the signal indicative of the brightness. Lower brightness (such as below 1000 lux) is normally perceived as more comfortable by a viewer for indoor illumination compared to higher brightness (such as above 1000 lux). With the present embodiment, adjustment of light of relatively high brightness (such as around 5000 lux) down to brightness below 1000 lux is enabled. Illumination from the window may then better resemble illumination from conventional indoor luminaries (which normally have a lower brightness compared to daylight).

According to an embodiment, the control unit may further be configured to control the window with respect to color temperature of light transmitted through the window based on the signal indicative of the brightness. For example, a lower color temperature may be set for a lower brightness for resembling incandescent lighting based illumination. For incandescent lighting based illumination, low brightness may often be associated with low color temperature and high brightness with high color temperature.

According to an embodiment, the control unit may further be configured to obtain a signal indicative of the brightness of light which is to be, and/or has been, transmitted through the window, and control the brightness of light emitted by a light source based on the signal indicative of the brightness. The light source may be arranged to be communicatively coupled to the control unit and to input light into an edge of the window. Hence, the system may further comprise a light source arranged to input light into an edge of the window. The window may be arranged to output light input into the edge of the window by the light source. Hence, light emitted by the light source enters the window at the edge and is guided in the window (by total internal reflection at the air/window interface). The light may be output from the window e.g. by particles (such as color particles) in the window or a rough structure at the window surface. The light from the light source may compensate for lack of daylight, such as during dusk, dawn, night time and/or cloudy weather. For example, when a reduced brightness is sensed, light output of light source may be increased. Further, the color temperature of light provided by the light source may be controlled by controlling the window, as light from the light source is transmitted through the window. For example, a light source emitting light of a relatively high color temperature (such as a solid state based light source) may be used, wherein the window may lower the color temperature of the light from the light source, which reduced the need of additional color adjustment means, such as phosphor. It will be appreciated that the present embodiment may be combined with any one of the preceding embodiments.

According to an embodiment, the window may be controllable at least with respect to the colors of magenta, yellow, and preferably also cyan, for effecting change of color temperature of light transmitted through the window. By adjusting the relative levels of these colors, various color temperatures may be provided. Preferably, the relative levels of these colors may be adjustable so as to achieve colors having a color point near (or on) the black body curve for resembling incandescent based illumination.

According to an embodiment, the window may comprise electrically controllable particles, wherein the color temperature of light transmitted through the window may be controllable by electrically controlling the particles. The particles may e.g. be comprised in a layer (or film) applied on the window surface. The particles may e.g. be controlled by means of electrodes. The particles may be colored for effecting changing of color of light transmitted through the window and/or black for effecting the amount of light transmitted through the window. The window may comprise an electronic skin (e-skin), wherein the electrically controllable particles are arranged in compartments (or cells). The particles may be electrically charged and controllable by selectively applying an electrical field substantially parallel to the e-skin surface (which may be referred to as in-plane electrophoresis). By selectively applying a voltage to electrodes of the e-skin, the particles are caused to be spread in the compartment, whereby the e-skin becomes colored/black, or concentrate at a concentration site of the compartment, such as at the edges of the compartment, whereby the e-skin becomes non-colored, or at least less colored/black, such as transparent or translucent. Such e-skin technology is described in more detail in the publications “Bright e-skin technology and applications: simplified grayscale e-paper”, Lenssen et al., Journal of SID 19/4 (2011) pp. 1-7, “Novel concept for full-color electronic paper”, Lenssen et al., Journal of SID 17/4 (2009) pp. 383-388, WO2009153709, WO2009153713 and WO2009153701, which are hereby incorporated by reference in their entirety.

According to an embodiment, the electrically controllable particles may include at least particles of a first color and particles of a second color, and wherein the particles of the first color may be controllable separate from or independently of the particles of the second color. Adjusting the color temperature of the window may be effected by controlling the particles of the first color relative to the particles of the second color. For example, the first color may be magenta and the second color may be yellow. According to an embodiment, the particles of the first color and the particles of the second color may be mixed in a single layer. The different colored particles may be independently controllable by having different electrical charges. Hence, the particles of the first color may have an electrical charge different from the electrical change of particles of the second color. For example, if the first color is desired, the particles of the first color may be caused to spread in the compartment, while the color of the second compartment is concentrated (e.g. at the edges of the compartment), such as further described in “Novel concept for full-color electronic paper”, Lenssen et al., Journal of SID 17/4 (2009) pp. 383-388.

According to an embodiment, the particles of the first color and the particles of the second color may be arranged in separate layers. Hence, the color of the window may be adjusted by independently adjusting the separate layers. Further, particles of two different colors (e.g. cyan and yellow) may be provided in a first layer and particles of two other colors (e.g. magenta and black) may be provided in a second layer, thereby enabling mixing of the four colors. It is noted that the invention relates to all possible combinations of features recited in the claims. Further objectives of, features of, and advantages with, the present aspect will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

This and other aspects will now be described in more detail, with reference to the appended drawings showing embodiments of the invention.

FIG. 1 shows a system according to an embodiment.

FIG. 2 shows an enlarged view of an electronic skin of a window of the system shown in FIG. 1.

All the Figures are schematic, not necessarily to scale, and generally only show parts which are necessary in order to elucidate the invention, wherein other parts may be omitted or merely suggested.

### DETAILED DESCRIPTION

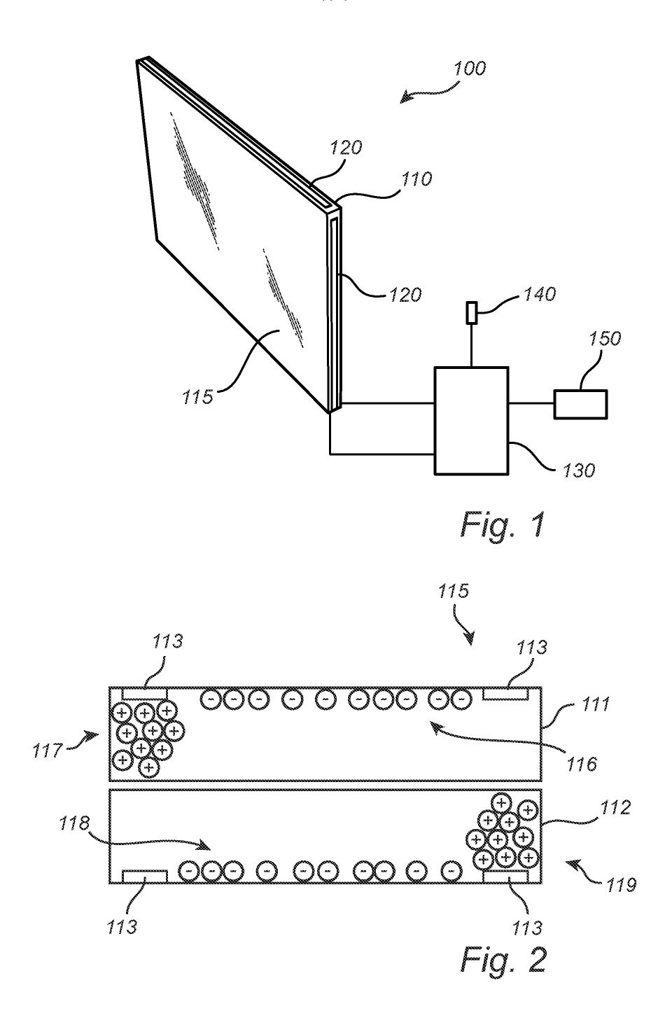

With reference to FIG. 1, a system 100 according to an embodiment will be described. The system 100 comprises a window 100, a sensor 140, one or more light sources 120, a user interface 150 and a control unit (or controller) 130. The window 100, sensor 140, light sources 120 and user interface 150 are communicatively coupled to the control unit 130. The system 100 may e.g. be arranged in a building for admitting daylight through the window 110 into the building. The system 100 may e.g. be comprised in a light guiding assembly, such as a skylight, for guiding light from an exterior of a building to an interior of the building.

The window 110 may comprise a pane made of a translucent or transparent rigid material, such as glass or plastic. The window 110 is adapted to controllably effect changing of color temperature of light transmitted through the window 110, preferably to a color temperature below 4000 K, preferably below 3400 K, and most preferably below 2700 K. The window 110 may be adjustable with respect to colors enabling tuning the color of the window 110 from yellow via orange to red for achieving relatively warm colors of the light transmitted through the window 110. These colors and color temperatures may be provided by mixing yellow and magenta. For achieving cooler color temperatures, cyan may be added to the mixing. Black may be used for blocking light.

For the purpose of effecting change of color of light transmitted through the window 110, the window 110 may comprise electronically controllable colored particles. For example an electronic skin (e-skin) 115 may be coupled to a surface of the window 110. The e-skin 115 may comprise one or more layers, each layer having a plurality of compartments (or cells) 111, 112, as illustrated in FIG. 2. In the present example, the e-skin 115 comprises a first layer and a second layer overlapping each other. A first compartment 111 of the first layers is arranged on (such as coupled to) a second compartment 112 of the second layer. The first compartment 111 encloses positively charged cyan particles 117 and negatively charged yellow particles 116, and the second compartment 112 encloses negatively charged magenta particles 118 and positively charged black particles 119. By adjusting an in-plane electrical field applied between the electrodes 113 of the first compartment 111, the yellow particles 116 can be caused to spread in the first compartment 111 and the cyan particles can be caused to concentrate at a relatively small region, such as at the edge of the first compartment 111, whereby the first compartment portion of the first layer turns yellow. Similarly, by adjusting an in-plane electrical field applied between the electrodes 113 of the second compartment 112, the magenta particles 118 can be caused to spread in the second compartment 112 and the black particles 119 can be caused to concentrate at a relatively small region, such as at the edge of the second compartment 112, whereby the second compartment portion of the second layer turns magenta. As the two layers overlap, a mix of yellow and magenta occurs in the e-skin 115. According to the same principle, the cyan and black particles 117, 119 can be caused to spread and the yellow and magenta particles 116, 118 to concentrate at the edges in the compartments 111, 112. Hence, the particles of a certain color are independently controllable with respect to the particles of other colors.

The light sources 120 are coupled to the edges of the window 110 such that light emitted by the light sources 120 enters, and is guided in, the window pane. The light may be coupled out from the window 110 by the colored particles in the electronic skin 115. The light sources 120 may e.g. comprise solid state based light elements, such as light emitting diodes (LEDs).

The sensor 140 is arranged to sense the color temperature, and preferably also the brightness, of light which is to be, and/or has been, transmitted through the window 110. Hence, the sensor 140 may be arranged at any side of the window 110, such as outdoors or indoors. Optionally, two or more sensors 140 may be comprised in the system 100, such as one for sensing color temperature and one for sensing brightness. The sensors 140 may be arranged on the same side of the window or on each side of the window 110. The sensor (or sensors) 140 is configured to transmit (wirelessly or by wire) a signal indicative of the sensed color temperature, and preferably also of the sensed brightness, to the control unit 130.

The control unit 130 is configured to control the window 110 with respect to color temperature, and preferably also with respect to the extent of light allowed to be transmitted through the window 110, and the light sources 120 with respect to the brightness of the light emitted by the light sources 120 (such as the dimming level of the light sources 120). The control performed by the controller 130 is based on the signals received from the sensor 140. The controller 140 may be communicatively coupled to the user interface 150. A user may select a predetermined light setting for the system 100 (e.g. specified in illumination brightness and/or color temperature). The control unit 130 may then control the window 110 and the light sources 120 to provide the selected light setting based on the sensed lighting conditions.

For example, a light setting with a brightness of 500 lux and a color temperature of 3000 K may be selected when the sensor 140 senses a brightness of 3000 lux and a color temperature of 4000 K outside the window 110. The control unit 130 may then adjust the color of the window 110 for effecting change of color temperature of light transmitted through the window 110 to a color temperature of about 3000 K. This may e.g. be achieved by spreading magenta and/or yellow particles in the compartments of the e-skin 115 of the window 110. Further, the control unit 130 may control the degree of light transmission of the window 110, such that the brightness of light which has been transmitted through the window 110 is about 500 lux. Hence, the window 110 is controlled to block some of the light input, which e.g. may be achieved by spreading black particles in the compartments of the e-skin 115 of the window 110. Further, as the light output from the window 110 has a proper brightness (i.e. 500 lux after passing the window 110), the control unit 110 may control the light sources 120 to be switched off.

According to another example, a light setting with a brightness of 500 lux and a color temperature of 3000 K (i.e. the same light setting as in the previous example) may be selected when the sensor 140 senses zero brightness (and consequently no color temperature) outside the window 110. The control unit 130 may then control the window 110 and the light sources 120 (based on a signal from the sensor 140), for example by switching on and adjusting the brightness of the light sources 120 to 500 lux, and adjusting the color of the window 110 for effecting change of color temperature of light emitted from the light sources 120 and transmitted through the window 110 to a color temperature of about 3000 K.

While embodiments have been illustrated and described in detail in the drawings and foregoing description, such illustration and description are to be considered illustrative or exemplary and not restrictive; the invention is not limited to the disclosed embodiments.

For example, even though a system for controlling illumination based on daylight is described as an exemplifying embodiment in the present specification, it will be appreciated that the system may as well be used for other applications where it is desirable to control the color temperature of light transmitted through a window.

Further, even though a window comprising an e-skin is described as an exemplifying embodiment in the present specification, it will be appreciated that the color temperature change of light transmitted through the window may as well be achieved by other techniques, such as electrophoresis, electrokinetic, electrowetting, suspended particles devices, liquid crystal or electro chromic techniques.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A control unit adapted to be communicatively coupled to a window,
the window being adapted to controllably effect changing of color temperature of light transmitted through the window,
the control unit being configured to:
obtain a signal indicative of the color temperature of light which is to be, and/or has been, transmitted through the window, and
control the window at least with respect to color temperature of light transmitted through the window based at least on said signal indicative of color temperature.

2. The control unit as defined in claim 1, further configured to:
control the window to effect change of color temperature of light transmitted through the window to a color temperature below 4000 K, preferably below 3400 K, and most preferably below 2700 K, based at least on said signal indicative of color temperature.

3. The control unit as defined in claim 1, further configured to:
obtain a signal indicative of the brightness of light which is to be, and/or has been, transmitted through the window, and
control the window based on said signal indicative of the brightness.

4. The control unit as defined in claim 3,
wherein the window is further controllable with respect to the extent of light allowed to be transmitted through the window,
the control unit being further configured to:
control the window with respect to the extent of light allowed to be transmitted through the window based on the signal indicative of the brightness.

5. The control unit as defined in claim 4, further configured to:
control the window with respect to the extent of light allowed to be transmitted through the window such that light transmitted through the window has an average brightness below 1000 lux, and preferably below 500 lux, based on the signal indicative of the brightness.

6. The control unit as defined in claim 3, further configured to:
control the window with respect to color temperature of light transmitted through the window based on the signal indicative of the brightness.

7. The control unit as defined in claim 1, further configured to:
obtain a signal indicative of the brightness of light which is to be, and/or has been, transmitted through the window, and
control the brightness of light emitted by a light source based on the signal indicative of the brightness, the light source being arranged to be communicatively coupled to the control unit and to input light into an edge of the window.

8. A system comprising:
a window adapted to controllably effect changing of color temperature of light transmitted through the window, and
a control unit as defined in any one of the preceding claims for controlling the window.

9. The system as defined in claim 8, further comprising a sensor configured to:
sense color temperature of light which is to be, and/or has been, transmitted through the window, and
transmit a signal indicative of the sensed color temperature to the control unit.

10. The system as defined in claim 8, further comprising:
a light source arranged to input light into an edge of the window,
wherein the window is arranged to output said light which has been input by the light source into the edge of the window.

11. The system as defined claim 8, wherein the window is controllable at least with respect to the colors of magenta, yellow, and preferably also cyan, for effecting change of color temperature of light transmitted through the window.

12. The system as defined in claim 8, wherein the window comprises electrically controllable particles, wherein the color temperature of light transmitted through the window is controllable by electrically controlling the particles.

13. The system as defined in claim 12, wherein the electrically controllable particles include at least particles of a first color and particles of a second color, and wherein the particles of the first color are controllable independently of the particles of the second color.

14. The system as defined in claim 13, wherein the particles of the first color and the particles of the second color are mixed in a single layer.

15. The system as defined in claim 13, wherein the particles of the first color and the particles of the second color are arranged in separate layers.
